(19) United States
(12) Patent Application Publication
(10) Pub. No.: US 2013/0298570 A1
(43) Pub. Date: Nov. 14, 2013

(54) METHOD FOR PRODUCING LIQUID HYDROGEN AND ELECTRICITY

(71) Applicants: Nigel Lawerence Dickens, Cheshire (GB); Nikunj Gupta, Houston, TX (US)

(72) Inventors: Nigel Lawerence Dickens, Cheshire (GB); Nikunj Gupta, Houston, TX (US)

(21) Appl. No.: 13/988,397

(22) PCT Filed: Nov. 16, 2011
(86) PCT No.: PCT/EP2011/070214

§ 371 Date: Jul. 16, 2013

Related U.S. Application Data
(60) Provisional application No. 61/415,951, filed on Nov. 22, 2010.

(51) Int. Cl. F02C 3/20; F25J 1/00

(52) U.S. Cl. CPC F02C 3/20; F25J 1/0002
USPC 60/780; 62/607

(57) ABSTRACT

The present invention provides a method for producing hydrogen and electricity utilizing a system suitable for producing liquid hydrogen and/or electricity. The system includes
a gas reforming unit for receiving and reforming a natural gas feed to produce a hydrogen-comprising gas;
an electricity generation unit for receiving and converting hydrogen from the gas reforming unit to generate electricity; and
a hydrogen liquefaction unit for receiving and liquefying hydrogen from the gas reforming unit. The hydrogen liquefaction unit is powered by at least part of the electricity produced by the electricity generation unit. During
a first period of operation, natural gas is provided to the gas reforming unit and the system is operated to export liquid hydrogen, and
during a second period of operation, natural gas is provided to the gas reforming unit and the system is operated to export electricity.

The invention relates to a method for producing liquid hydrogen and electricity.

In recent years increasing attention is given to use of hydrogen to generate electricity (power). This power can for instance be used to drive a hydrogen liquefaction process. The hydrogen can be produced by reforming a hydrocarbon feedstock. This scheme is more commonly known as Integrated Reforming Combined Cycle (IRCC) and is typically combined with a CO₂ capture step. Such a process is for instance described in JP9291832A, wherein liquefied hydrogen is produced by supplying, as fuel, hydrogen from a hydrogen generator directly to the combustor of a combined cycle plant, and driving a hydrogen liquefying compressor by the output of the combined cycle plant. A disadvantage of such a process is that it requires providing a dedicated combined cycle power generation unit for producing liquid hydrogen, losing the economy of scale.

There is a need in the art for a method for producing liquid hydrogen, wherein optimal use is made of the economy of scale.

It has now been found that by using a method for producing liquid hydrogen and electricity, optimal use can be made of the economy of scale. This method comprises responding to the external electricity demand by adjusting the ratio of liquid hydrogen and electricity produced.

Accordingly, the present invention provides a method for producing hydrogen and electricity, comprising providing a system suitable for producing liquid hydrogen and/or electricity, comprising at least:

a) a gas reforming unit arranged to receive a natural gas feed and to reform a natural gas to produce a hydrogen-comprising gas;
b) an electricity generation unit arranged to receive at least part of the hydrogen in the hydrogen-comprising gas and to convert the hydrogen to generate electricity; and
c) a hydrogen liquefaction unit arranged to receive part of the hydrogen in the hydrogen-comprising gas and to liquefy the hydrogen to produce liquid hydrogen, which hydrogen liquefaction unit during operation is powered by at least part of the electricity produced by the electricity generation unit,

during operation which system is arranged to export liquid hydrogen and/or electricity,

wherein:

i) during a first period, natural gas is provided to the gas reforming unit and the system is operated to export liquid hydrogen; and
ii) during a second period, natural gas is provided to the gas reforming unit and the system is operated to export electricity.

In the method according the invention liquid hydrogen and electricity may be co-produced. The general term that is used to describe such methods is polygeneration or polygen and generally refers to methods for co-producing at least two products for external use. Examples include for instance power and gaseous hydrogen using an Integrated Reforming Combined Cycle (IRCC).

In the method according the invention, hydrogen is liquefied and the power to liquefy the hydrogen is provided internally by combusting part of the hydrogen to generate electricity. The electricity produced may also be used to satisfy the internal power demand of the system suitable to produce liquid hydrogen and electricity. An advantage of the present method is that it enables the use of a commercial scale Combined Cycle or IRCC power generating systems, which may produce more power than required to satisfy the internal power demand. The excess power produced, i.e. after the internal power demand has been satisfied, may be exported externally, for instance to the utility grid. By combining the liquefaction of hydrogen with the production of power by combustion of hydrogen, a solution is provided to the fluctuating demand for power during peak and off-peak hours. During peak hours, external power demand is high. Reference herein to external power demand is to the power demand other that the internal power demand. In order to satisfy the power demand during peak hours, sufficient power generating capacity must be provided and in addition sufficient hydrogen generation capacity must be provided in the form of natural gas reforming capacity. However, during off-peak hours external power demand is low, or alternatively an uneconomically attractive tariff is applicable, and the provided power generating and reforming capacity is not fully utilised or even utilised below the minimum base-load operation. In the method according to the present invention, during off peak hours, the power which is not used to satisfy an external power demand is used to liquefy hydrogen. This allows operating the existing reforming and power generating capacity at least at base-load, preferably above base-load, while redirecting part of the hydrogen produced to hydrogen liquefaction unit and liquefying the hydrogen. The liquid hydrogen can be exported to satisfy an external liquid hydrogen demand or exported to be stored for later use.

In the method according to the invention liquid hydrogen and/or electricity are produced using a system suitable for producing liquid hydrogen and/or electricity.

The system suitable for producing liquid hydrogen and/or electricity, comprises at least a gas reforming unit arranged to receive a natural gas feed and to reform a natural gas to produce a hydrogen-comprising gas. The gas reforming unit may be any unit suitable for reforming a natural gas to a hydrogen-comprising gas. Examples of such unit include but are not limited to Steam Methane reformers, Autothermal reformers, Partial Oxidation reformers and Catalytic Partial Oxidation reformers. Reforming of the natural gas may take place by reacting the natural gas, in particular the methane in the natural gas, with oxygen, steam and/or carbon dioxide to obtain hydrogen and optionally carbon monoxide and/or carbon dioxide. Typically, the hydrogen-comprising gas is a mixture comprising hydrogen and at least one of carbon monoxide and carbon dioxide, often referred to a synthesis gas. The hydrogen content in the hydrogen-comprising gas may be increased by subjecting the synthesis gas to a water-gas-shift reactor, wherein part carbon monoxide is converted with steam to hydrogen and carbon dioxide. In a particular embodiment, wherein the natural gas is reformed with steam, the hydrogen content in the obtained hydrogen-comprising gas can be increased by withdrawing hydrogen from the reaction and thereby pushing the equilibrium in the reactor toward the production of hydrogen and carbon dioxide instead of hydrogen and carbon monoxide. Reference is made to EP2035329, hereby incorporated by reference, wherein such a process is described.

Reforming of natural gas is well known in the art and does not require further description.

The system suitable for producing liquid hydrogen and/or electricity, further comprises an electricity generation unit arranged to receive at least part of the hydrogen in the hydrogen-comprising gas and to convert the hydrogen to generate electricity. The hydrogen in the hydrogen-comprising gas obtained from the reformer unit is at least partially provided to an electricity generation unit and combusted, preferably with oxygen, to generated power. The electricity generation unit may be any unit or system that can generate electricity by combustion hydrogen. The electricity generation unit may be a unit or system that generates electricity by the direct combustion of hydrogen to power a mechanical power generator. Example of such systems include Combined Cycle power generators, wherein during operation the hydrogen is converted to electricity by direct combustion with oxygen in a gas turbine arranged to drive a generator, and conventional boiler-based power generators. Preferably a Combined Cycle power generator is used. Alternatively, the power generating unit may be a unit or system that generates electricity by the indirect combustion of hydrogen, such as a hydrogen fuelled fuel cell-based power generator, wherein the hydrogen is indirectly combusted with an oxidant, preferably oxygen, inside the fuel cell.

Optionally, the power generating unit comprises more than one kind of power generator.

Power generation based on the combustion of hydrogen-comprising gases is well known in the art and does not require further description.

The system suitable for producing liquid hydrogen and/or electricity, further comprises a hydrogen liquefaction unit arranged to receive part of the hydrogen in the hydrogen-comprising gas and to liquefy the hydrogen to produce liquid hydrogen, which hydrogen liquefaction unit during operation is powered by at least part of the electricity produced by the electricity generation unit. When desired part of the hydrogen in the hydrogen-comprising gas obtained from the reformer unit is provided to a hydrogen liquefaction unit. The hydrogen liquefaction unit may be any suitable hydrogen liquefaction unit. A preferred hydrogen liquefaction unit is a hydrogen liquefaction unit that liquefies hydrogen by a process wherein the hydrogen is cooled and subsequently liquefied by a series of compression, cooling and expansion cycles (Carnot cycles). One suitable example of such a hydrogen liquefaction unit and liquefaction process is described in WO2005/080892, hereby incorporated by reference. In the method according to the present invention at least part of the electricity required to power the compressors and/or coolers in the hydrogen liquefaction unit during operation is provided by the electricity generating unit.

Preferably, the system suitable for producing liquid hydrogen and/or electricity also comprises a separation unit suitable to separate hydrogen from a gas containing hydrogen and arranged to receive at least part of the hydrogen-comprising gas obtained from the reforming unit during operation and arranged to provide hydrogen to the liquefaction unit. The separation unit may be any separation unit suitable to separate hydrogen from a gas containing hydrogen including but not limited to a pressure swing adsorption unit or membrane-based separation unit. In order to allow for an efficient liquefaction of the hydrogen, the hydrogen should be essentially pure, preferably 99 wt % pure or higher, based on the hydrogen provided to the hydrogen liquefaction unit. The reminder of the hydrogen-comprising as will typically comprise predominantly nitrogen, carbon dioxide and carbon monoxide. In the case, pure oxygen or essentially pure oxygen or steam was used to reform the natural gas, the reminder of the hydrogen-comprising as will predominantly comprise carbon dioxide and carbon monoxide. Optionally, after combustion of the carbon monoxide, this gas stream can be subjected to a carbon dioxide capture and sequestration process to reduce the carbon dioxide footprint of the method. The heat of combustion of combusting the carbon monoxide may be used to generate additional power.

Preferably, also the hydrogen provided to the electricity generating using is obtained by first separating the hydrogen from the remainder of the hydrogen-comprising gas in a, preferably the same, separation unit suitable to separate hydrogen from a gas containing hydrogen and arranged to provided hydrogen to the electricity generating unit. As a result, the carbon dioxide footprint of the method may be even further reduced. Alternatively, the combustion flue gas of the electricity generating unit is provided to a separation unit suitable to separate carbon dioxide from a gas containing carbon dioxide. The separation unit may be any separation unit suitable to separate carbon dioxide from a gas containing carbon dioxide including but not limited to a pressure swing adsorption unit or membrane-based separation unit. This is particularly advantageous when the hydrogen-comprising gas does not comprise significant amounts of nitrogen, as the carbon dioxide can be easily be obtained in concentrated form from the combustion flue gas by condensing the steam in the flue gas. This has the additional advantage that the heat of combustion of combusting the carbon monoxide is used directly to generate additional power.

In a preferred embodiment of the method according to the invention, the natural gas is reformed to produce a hydrogen-comprising gas by a partial oxidation process and hydrogen is converted to electricity by direct combustion with oxygen in a gas turbine arranged to drive a generator, and the system suitable for producing liquid hydrogen and/or electricity further comprises a further separation unit, suitable to separate air into an oxygen-rich fraction and an oxygen-lean fraction, arranged to receive air, separate the air and to provide at least part of an oxygen-rich fraction to partial oxidation process and provide at least part of an oxygen-lean fraction to the gas turbine. The further separation unit may be any separation unit suitable to separate air into an oxygen-rich fraction and an oxygen-lean fraction including but not limited to a pressure swing adsorption unit or membrane-based separation unit. By providing the oxygen-rich fraction to the natural gas reforming and reforming the natural gas with the oxygen, while reducing the amount of nitrogen otherwise supplied in the air, the obtained hydrogen-comprising gas is less diluted with nitrogen. As a result, the volume of the reformer unit can be reduced or used more efficiently, and the volume of the separator for separating the hydrogen from the hydrogen-comprising gas can be decreased or at least used more efficiently. The oxygen-lean fraction, which is typically rich in nitrogen is suitably used to dilute the hydrogen provided to the electricity generating unit for combustion with oxygen. Any oxygen remaining in the oxygen-lean fraction can be combusted with the hydrogen.

During operation, the system suitable for producing liquid hydrogen and/or electricity is arranged to export liquid hydrogen and/or electricity. For instance means are provided to connect to electricity generating unit to the utility grid or any other external electricity network. In addition means are provided to connect the hydrogen liquefaction unit to a storage facility for storing liquid hydrogen, a liquid hydrogen utility pipeline, a facility for filling liquid hydrogen supply vehicles or a facility for refueling vehicles.

In the method according to the present invention, the ability to efficiently respond to changes in the external electricity demand, is obtained by operating the system suitable for producing liquid hydrogen and/or electricity such that during periods of low external power demand, the electricity produced in excess of the external demand is directed to the hydrogen liquefaction unit and used to liquefy hydrogen. Therefore, in the method according to the present invention, during a first period natural gas is provided to the gas reforming unit and the system suitable for producing liquid hydrogen and/or electricity is operated to export liquid hydrogen. During this first period, the natural gas is provided to the reforming unit and reformed to a hydrogen-comprising gas. Part of the hydrogen in the hydrogen-comprising gas, preferably after having been separated from the remainder of the hydrogen-comprising gas, is provided to the hydrogen liquefaction unit to be liquefied. The remainder of the hydrogen in the hydrogen-comprising gas is provided to the electricity generating unit and combusted to generate electricity. The ratio of hydrogen provided to the liquefaction unit and the electricity generating unit is preferably chosen such that sufficient electricity is produced to satisfy the power demand of the hydrogen liquefaction unit and more preferably satisfy the power demand of the entire system suitable for producing liquid hydrogen and/or electricity. In any case sufficient hydrogen is provided to the electricity generating unit to allow it to run on base-load. Reference herein to base-load is to the minimal operation condition for the electricity generating unit to maintain operation. Optionally, during the first period additional electricity is imported externally, for instance from the utility grid or another electricity network. The liquid hydrogen is exported for example to a storage facility for storing liquid hydrogen, a facility for filling liquid hydrogen supply vehicles or a facility for refueling vehicles.

During a second period of the method according to the present invention, natural gas is provided to the gas reforming unit and the system suitable for producing liquid hydrogen and/or electricity is operated to export electricity. During this first period, the natural gas is provided to the reforming unit and reformed to a hydrogen-comprising gas. Part or all of the hydrogen in the hydrogen-comprising gas, preferably after having been separated from the remainder of the hydrogen-comprising gas, is provided to the electricity generating unit and combusted to generate electricity. The electricity produced is used to satisfy the internal power demand of the system and the excess electricity is exported externally, for instance to the utility grid or another electricity network.

By operating the system in the manner prescribed by the method according to the invention, the electricity generating unit will at all timed be operated at least at base-load, while the reforming unit may continuously be operated a full or near full capacity.

In a preferred embodiment, during the first period of the method according to the invention also some or more electricity in excess of the internal power demand is produced and subsequently exported for instance to the utility grid or another electricity network. As a result the, albeit lower, but still existing external power demand can be satisfied. In addition, this allows both the electricity generating unit and the reforming unit to be operated closer to full capacity.

In a further preferred embodiment, during the first period of the method according to the invention also some or more electricity in excess of the internal power demand is produced and subsequently exported for instance to the utility grid or another electricity network, while during the second period next to electricity also liquid hydrogen is exported. In this embodiment, during the second period part of the hydrogen in the hydrogen-comprising gas is provided to the hydrogen liquefaction unit to be liquefied and part of the electricity produced by the electricity generating unit is used to power the hydrogen liquefaction unit. As a result, a continuous export of liquid hydrogen is provided.

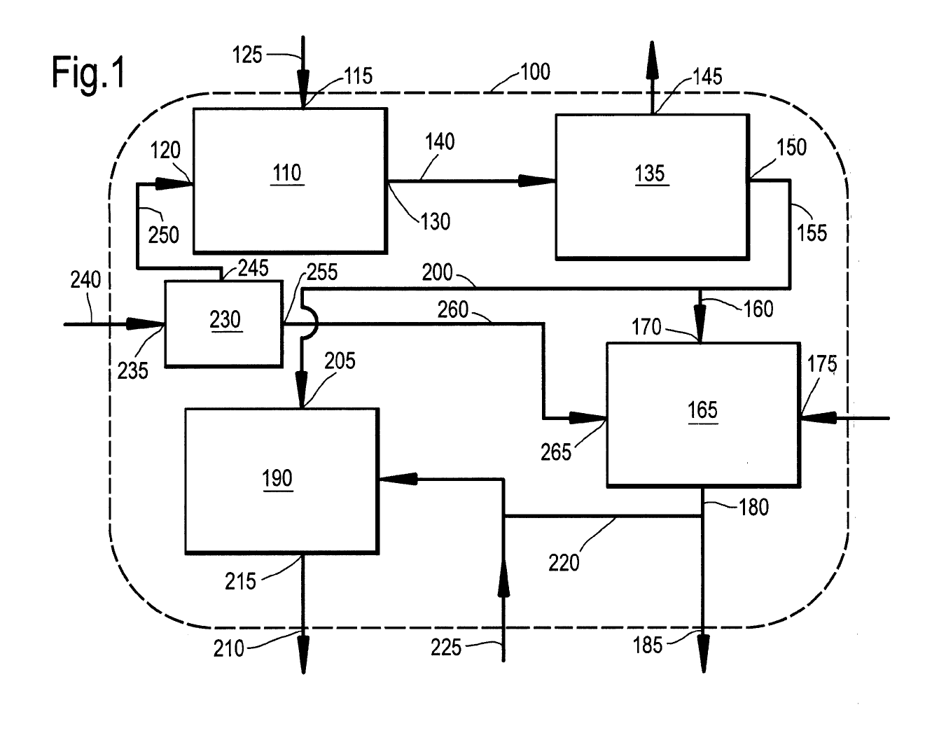

In FIG. 1, a schematic representation is provided of a system suitable for producing liquid hydrogen and/or electricity as may be used in the method according to the invention.

In FIG. 1, system suitable for producing liquid hydrogen and/or electricity 100, comprises reformer unit 110, with inlet for natural gas 115 and an inlet for steam, oxygen or an oxygen-comprising gas 120. Natural gas is provided via conduit 125 to reformer unit 110. A hydrogen-comprising gas exits reformer unit 110 via outlet 130 and is passed to separation unit 135, suitable to separate hydrogen from the hydrogen-comprising gas, via conduit 140. A carbon dioxide and/or carbon monoxide comprising gas stream exits separator unit via outlet 145 and may be provided to a carbon dioxide sequestration process (not shown), optionally via one or more other separation units and/or combustors for combustion carbon monoxide.

A stream comprising predominantly hydrogen exits separation unit 135 via outlet 150 and conduit 155. Part of the hydrogen is provided via conduit 160 to electricity generating unit 165, through inlet 170. Electricity generating unit 165 also comprises one or more inlets 175 for oxygen or an oxygen-comprising gas. The hydrogen is combusted in electricity generating unit 165 to produce electricity, which exits electricity generating unit 165 via conducting means 180. Part of the electricity is exported from system 100 via conducting means 185.

Part of the hydrogen may be provided to hydrogen liquefaction unit 190 via conduit 200 and inlet for hydrogen 205, where it is liquefied and exits hydrogen liquefaction unit 190 and system 100 as liquid hydrogen via conduit 210 and outlet for liquid hydrogen 215. The liquid hydrogen may be exported to one or more of a storage facility for storing liquid hydrogen, a liquid hydrogen utility pipeline, a facility for filling liquid hydrogen supply vehicles or a facility for refueling vehicles (not shown). At least part of the electricity needed to power to hydrogen liquefaction unit 190 is provided from the electricity generating unit 165 via conducting means 180 and 220. Optionally, electricity is imported into system 100 to hydrogen liquefaction unit 190 via conducting means 225.

Air separator 230 may be provided in system 100, comprising inlet 235 to receive air via conduit 240. The air is separated in air separator 230, and an oxygen-rich fraction exits air separator 230 via outlet 245 and is provided via conduit 250 to inlet 120 of reformer unit 110. An oxygen-lean fraction exits air separator 230 via outlet 255 and is provided as diluent via conduit 260 to inlet 265 of electricity generating unit 165, wherein inlet 26 may be the same as one or more of inlets 175.

1. A method for producing hydrogen and electricity, comprising providing a system suitable for producing liquid hydrogen and/or electricity, comprising at least:
a) a gas reforming unit arranged to receive a natural gas feed and to reform a natural gas to produce a hydrogen-comprising gas;
b) a electricity generation unit arranged to receive at least part of the hydrogen in the hydrogen-comprising gas and to convert the hydrogen to generate electricity; and
c) a hydrogen liquefaction unit arranged to receive part of the hydrogen in the hydrogen-comprising gas and to liquefy the hydrogen to produce liquid hydrogen, which hydrogen liquefaction unit during operation is powered by at least part of the electricity produced by the electricity generation unit,
during operation which system is arranged to export liquid hydrogen and/or electricity,
wherein:
i) during a first period, natural gas is provided to the gas reforming unit and the system is operated to export liquid hydrogen; and
ii) during a second period, natural gas is provided to the gas reforming unit and the system is operated to export electricity.

2. A method according to claim 1, wherein during the first period additional electricity is imported.

3. A method according to claim 1, wherein
i) during the first period, the system is operated to export liquid hydrogen and electricity; and
ii) during the second period, the system is operated to export electricity.

4. A method according to claim 1, wherein
i) during the first period, the system is operated to export liquid hydrogen and electricity; and
ii) during the second period, the system is operated to export liquid hydrogen and electricity.

5. A method according to claim 1, wherein during the first period, the system suitable for producing liquid hydrogen and/or electricity is operated at least at base-load conditions.

6. A method according to claim 1, wherein the first period overlaps with a period of low external electricity demand.

7. A method according to claim 1, wherein the system suitable for producing liquid hydrogen and/or electricity further comprises a separation unit suitable to separate hydrogen from a gas containing hydrogen and arranged to receive at least part of the hydrogen-comprising gas and provide hydrogen to the liquefaction unit.

8. A method according to claim 1, wherein during operation the natural gas is reformed to produce a hydrogen-comprising gas by a steam reforming process or a partial oxidation process.

9. A method according to claim 1, wherein during operation the hydrogen is converted to electricity by direct combustion with oxygen in a gas turbine arranged to drive a generator or by indirect combustion with oxygen in a fuel cell.

10. A method according to claim 8, wherein the natural gas is reformed to produce a hydrogen-comprising gas by a partial oxidation process and hydrogen is converted to electricity by direct combustion with oxygen in a gas turbine arranged to drive a generator, and the system suitable for producing liquid hydrogen and/or electricity further comprises a separation unit, suitable to separate air into an oxygen-rich fraction and an oxygen-lean fraction, arranged to receive air, separate the air and to provide at least part of a oxygen-rich fraction to partial oxidation process and provide at least part of a oxygen-lean fraction to the gas turbine.
